(19) United States
(12) Patent Application Publication
(10) Pub. No.: US 2024/0385365 A1
(43) Pub. Date: Nov. 21, 2024

(54) OPTICAL WAVEGUIDE DEVICE

(71) Applicant: SHINKO ELECTRIC INDUSTRIES CO., LTD., Nagano (JP)

(72) Inventors: Motoyuki FUKUHARA, Nagano (JP); Hisashi KANEDA, Nagano (JP)

(21) Appl. No.: 18/660,669

(22) Filed: May 10, 2024

(30) Foreign Application Priority Data
May 15, 2023 (JP) 2023-079898
Nov. 21, 2023 (JP) 2023-197113

(51) Int. Cl. G02B 6/12

(52) U.S. Cl. CPC G02B 6/12; G02B 2006/12061

(57) ABSTRACT

An optical waveguide device includes an optical waveguide substrate, and an optical semiconductor element including a silicon waveguide and mounted on the optical waveguide substrate. The optical waveguide substrate includes a substrate, a first cladding layer formed on the substrate, a first core layer formed on the first cladding layer, and a second cladding layer formed on the first cladding layer and the first core layer. The silicon waveguide includes a second core layer optically coupled to the first core layer, and the optical semiconductor element is fixed to the substrate by the second cladding layer.

### CROSS-REFERENCE TO RELATED APPLICATIONS

This application is based upon and claims priority to Japanese Patent Application No. 2023-079898, filed on May 15, 2023, and Japanese Patent Application No. 2023-197113, filed on Nov. 21, 2023, the entire contents of which are incorporated herein by reference.

### FIELD

Certain aspects of the embodiments discussed herein are related to optical waveguide devices, and methods for manufacturing optical waveguide devices.

### BACKGROUND

With the increase in high-speed large-capacity transmission of communication data due to the development of the information society, optical waveguides for transmitting high-speed signals as optical signals are being developed in order to compensate for the limit of the transmission speed of electrical signals.

In an optical waveguide device including an optical waveguide, a core layer of a polymer waveguide included in an optical waveguide substrate, and a core layer of a silicon waveguide included in an optical semiconductor element, are optically coupled.

Related art include Japanese Laid-Open Patent Publication No. 2018-200333, International Publication Pamphlet No. WO 2018/168783, and Japanese Laid-Open Patent Publication No. 2014-81586, for example.

In the conventional optical waveguide device, a foreign material may become mixed in between the core layer of the polymer waveguide included in the optical waveguide substrate and the core layer of the silicon waveguide included in the optical semiconductor element.

### SUMMARY

One object of the present disclosure is to provide an optical waveguide device and a method for manufacturing the optical waveguide device, which can prevent mixing of the foreign material.

According to one aspect of the present disclosure, an optical waveguide device includes an optical waveguide substrate; and an optical semiconductor element including a silicon waveguide and mounted on the optical waveguide substrate, wherein the optical waveguide substrate includes a substrate; a first cladding layer formed on the substrate; a first core layer formed on the first cladding layer; and a second cladding layer formed on the first cladding layer and the first core layer, the silicon waveguide includes a second core layer optically coupled to the first core layer, and the optical semiconductor element is fixed to the substrate by the second cladding layer.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1A and FIG. 1B are diagrams illustrating an example of an optical waveguide device according to a first embodiment;

FIG. 2 is a diagram (part 1) illustrating an example of a method for manufacturing the optical waveguide device according to the first embodiment;

FIG. 3A and FIG. 3B are diagrams (part 2) illustrating the example of the method for manufacturing the optical waveguide device according to the first embodiment;

FIG. 4A and FIG. 4B are diagrams (part 3) illustrating the example of the method for manufacturing the optical waveguide device according to the first embodiment;

FIG. 5A and FIG. 5B are diagrams (part 4) illustrating the example of the method for manufacturing the optical waveguide device according to the first embodiment;

FIG. 6A and FIG. 6B are diagrams (part 5) illustrating the example of the method for manufacturing the optical waveguide device according to the first embodiment;

FIG. 7 is a diagram (part 6) illustrating the example of the method for manufacturing the optical waveguide device according to the first embodiment;

FIG. 8A, FIG. 8B, FIG. 8C, and FIG. 8D are diagrams (part 7) illustrating the example of the method for manufacturing the optical waveguide device according to the first embodiment;

FIG. 9A, FIG. 9B, FIG. 9C, and FIG. 9D are diagrams (part 8) illustrating the example of the method for manufacturing the optical waveguide device according to the first embodiment;

FIG. 10A, FIG. 10B, FIG. 10C, and FIG. 10D are diagrams (part 9) illustrating the example of the method for manufacturing the optical waveguide device according to the first embodiment;

FIG. 11A and FIG. 11B are diagrams (part 10) illustrating the example of the method for manufacturing the optical waveguide device according to the first embodiment;

FIG. 12A and FIG. 12B are diagrams (part 11) illustrating the example of the method for manufacturing the optical waveguide device according to the first embodiment;

FIG. 13A and FIG. 13B are diagrams illustrating an example of the optical waveguide device according to a second embodiment;

FIG. 14 is a diagram (part 1) illustrating an example of the method for manufacturing the optical waveguide device according to the second embodiment;

FIG. 15A and FIG. 15B are diagrams (part 2) illustrating the example of the method for manufacturing the optical waveguide device according to the second embodiment;

FIG. 16A and FIG. 16B are diagrams (part 3) illustrating the example of the method for manufacturing the optical waveguide device according to the second embodiment; and

FIG. 17A and FIG. 17B are diagrams (part 4) illustrating the example of the method for manufacturing the optical waveguide device according to the second embodiment.

### DESCRIPTION OF EMBODIMENTS

Hereinafter, embodiments of the present disclosure will be described in detail with reference to the accompanying drawings. In the present specification and the drawings, constituent elements having substantially the same functional configuration are designated by the same reference numerals, and a redundant description thereof may be omitted.

### First Embodiment

A first embodiment will be described. The first embodiment relates to an optical waveguide device.

### [Structure of Optical Waveguide Device]

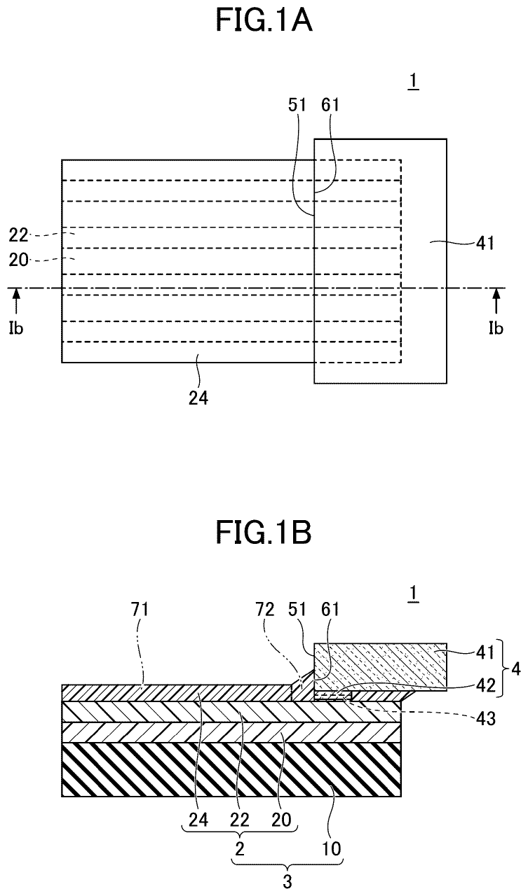

The structure of the optical waveguide device according to the first embodiment will be described. FIG. 1A and FIG. 1B are diagrams illustrating an example of the optical waveguide device according to the first embodiment. FIG. 1A is a plan view of the optical waveguide device, and FIG. 1B is a cross sectional view of the optical waveguide device taken along a line Ib-Ib in FIG. 1A.

As illustrated in FIG. 1A and FIG. 1B, an optical waveguide device 1 according to the first embodiment mainly includes an optical waveguide substrate 3 and an optical semiconductor element 4. The optical semiconductor element 4 is mounted on the optical waveguide substrate 3.

The optical waveguide substrate 3 includes a substrate 10, and an optical waveguide 2. The optical waveguide 2 is provided on one surface of the substrate 10. The optical waveguide 2 includes a first cladding layer 20, a plurality of core layers 22, and a second cladding layer 24. The optical waveguide 2 is a polymer waveguide.

An interconnect pattern (not illustrated) or an electrode (not illustrated) may be formed on the substrate 10. In addition, a semiconductor chip (not illustrated), an electronic component (not illustrated), or the like may be mounted on the substrate 10.

In the present embodiment, for the sake of convenience, the side of the optical waveguide device 1 provided with the optical waveguide 2, with reference to the substrate 10, is referred to as an upper side or one side, and the opposite side of the optical waveguide device 1 is referred to as a lower side or the other side. The surface of each portion on the side of the optical waveguide 2 provided with the optical waveguide 2 is referred to as one surface or an upper surface, and the surface of each portion on the opposite side of the optical waveguide device 1 is referred to as the other surface or a lower surface. However, the optical waveguide device 1 can be used in an upside-down state or can be arranged at an arbitrary angle. Further, a plan view of an object refers to a view of the object viewed from above in a normal direction to one surface of the substrate 10, and a planar shape of the object indicates a shape of the object in the plan view viewed from above in the normal direction to the one surface of the substrate 10.

The first cladding layer 20 is provided on the substrate 10. The first cladding layer 20 may be provided on the entire upper surface of the substrate 10. A material used for the first cladding layer 20 is an organic resin, such as an epoxy resin, a polyimide resin, or the like, for example.

The plurality of core layers 22 are provided in a band (or strip) pattern on the first cladding layer 20. A width of the core layer 22 is in a range of 5 μm to 10 μm, for example, and a height of the core layer 22 is in a range of 5 μm to 10 μm, for example. In the present embodiment, the core layer 22 has a cross sectional area that is extremely small (that is, a micro cross sectional area) in order to obtain a single-mode optical waveguide. A material used for the core layer 22 is an organic resin, such as an epoxy resin, a polyimide resin, or the like, for example. The core layer 22 is an example of a first core layer.

The second cladding layer 24 is provided on the first cladding layer 20 and the plurality of core layers 22. The second cladding layer 24 covers the plurality of core layers 22. A material used for the second cladding layer 24 is an organic resin, such as an epoxy resin, a polyimide resin, or the like, for example. A thickness of the second cladding layer 24 is in a range of approximately 10 μm to approximately 30 μm, for example.

In the optical waveguide 2, a refractive index of the core layer 22 is higher than refractive indexes of the first cladding layer 20 and the second cladding layer 24.

The optical semiconductor element 4 is fixed to the substrate 10 by the second cladding layer 24 with the first cladding layer 20 interposed between the substrate 10 and the second cladding layer 24. The optical semiconductor element 4 includes a base 41, and a silicon waveguide 42. The base 41 includes an optical circuit or the like optically coupled to the silicon waveguide 42. The silicon waveguide 42 is provided on a lower surface of the base 41. The silicon waveguide 42 includes a core layer 43. The core layer 43 opposes the core layer 22 of the optical waveguide 2. For example, a lower surface of the core layer 43 opposes an upper surface of the core layer 22. A cross section of the core layer 43 is smaller than a cross section of the core layer 22 of the optical waveguide 2. A width of the core layer 43 is in a range of 0.2 μm to 1 μm, for example, and a height of the core layer 43 is a range of 0.2 μm to 1 μm, for example. The core layer 43 is optically coupled to the core layer 22. For example, light leaking from the lower surface of the core layer 43 enters the core layer 22 of the optical waveguide 2. The optical semiconductor element 4 can be manufactured by silicon photonics. The core layer 43 is an example of a second core layer.

The core layer 22 of the optical waveguide 2 and the core layer 43 of the silicon waveguide 42 may be separated from each other. That is, a gap may be formed between the core layer 22 and the core layer 43. In the case where the core layer 22 of the optical waveguide 2 and the core layer 43 of the silicon waveguide 42 are separated from each other, an optical loss of the optical coupling can easily be reduced.

The optical semiconductor element 4 has a first side surface 51 intersecting the plurality of core layers 22 in the plan view. The second cladding layer 24 has a first surface 61 in contact with the first side surface 51. The second cladding layer 24 has a flat region 71, and a sloping region 72 located between the flat region 71 and the optical semiconductor element 4. In the flat region 71, a height of an upper surface of the second cladding layer 24 with reference to the upper surface of the substrate 10 is constant (that is, the heights are the same). On the other hand, in the sloping region 72, the height of the upper surface of the second cladding layer 24 with reference to the upper surface of the substrate 10 increases in a direction from the flat region 71 toward the optical semiconductor element 4. The sloping region 72 includes the first surface 61.

In the optical waveguide substrate 3, a connector (not illustrated) or the like may be coupled to an end surface (a left end surface in FIG. 1A and FIG. 1B) on the opposite side from an end surface (a right end surface in FIG. 1A and FIG. 1B) where the silicon waveguide 42 and the core layer 22 are optically coupled. Further, in the optical semiconductor element 4, an interconnect substrate (not illustrated) mounted with a semiconductor chip or the like may be connected to the side (the right side in FIG. 1A and FIG. 1B) opposite to the side (the left side in FIG. 1A and FIG. 1B) where the silicon waveguide 42 and the core layer 22 are optically coupled.

### [Method for Manufacturing Optical Waveguide Device]

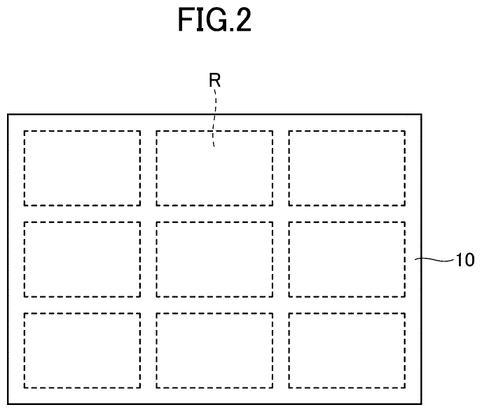

Next, a method for manufacturing the optical waveguide device according to the first embodiment will be described. FIG. 2 through FIG. 12B are diagrams illustrating the method for manufacturing the optical waveguide device according to the first embodiment.

First, as illustrated in FIG. 2, the substrate 10 is prepared. The substrate 10 is formed of an insulating resin material, such as a glass epoxy resin or the like, for example. The substrate 10 may be a rigid substrate having a high rigidity, or a flexible substrate having a low rigidity. The substrate 10 includes an insulator called a support or a base material. The substrate 10 is a large substrate for multiple chamfering, partitioned into a plurality of product regions R. The large substrate is finally cut along outer peripheries of the product regions R, so as to obtain individual optical waveguide devices.

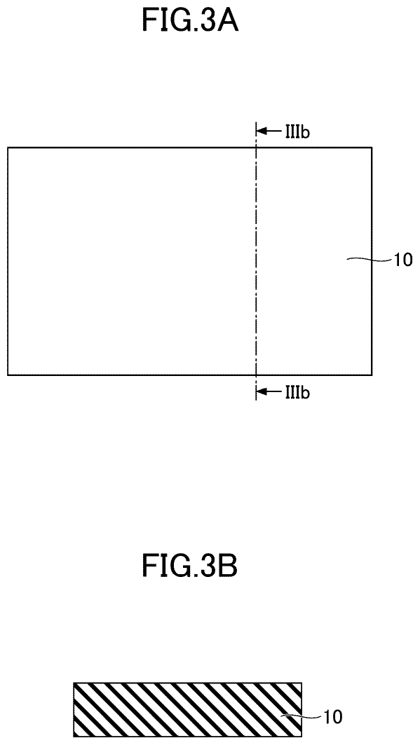

In FIG. 3A and the subsequent drawings, one product region R of the substrate 10 illustrated in FIG. 2 is partially illustrated and described. FIG. 3A and FIG. 3B partially illustrate one product region R of the substrate 10 illustrated in FIG. 2. FIG. 3A is a plan view of the product region R, and FIG. 3B is a cross sectional view of the product region R taken along a line IIIb-IIIb in FIG. 3A.

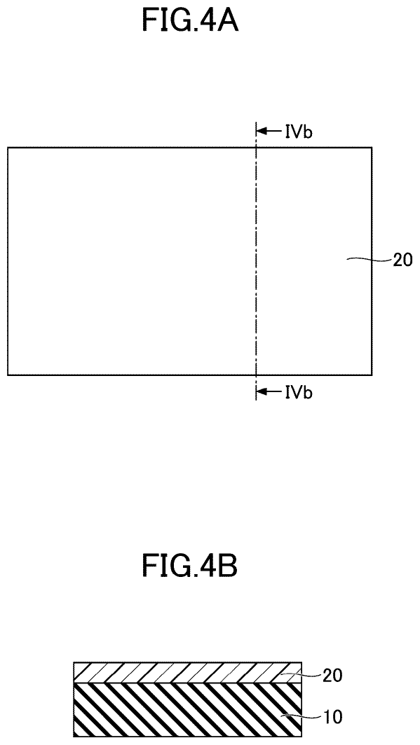

Next, as illustrated in FIG. 4A and FIG. 4B, the first cladding layer 20 is formed on the substrate 10. The first cladding layer 20 is obtained by irradiating ultraviolet light on a photocurable resin, and thereafter performing a heat treatment at a temperature in a range of 150° C. to 200° C., so as to cure the photocurable resin. FIG. 4A is a plan view of the product region R, and FIG. 4B is a cross sectional view of the product region R taken along a line IVb-IVb in FIG. 4A.

The first cladding layer 20 is formed on the entire surface of the substrate 10 that is partitioned into the plurality of product regions R. In a case where the first cladding layer 20 is patterned to adjust an outer shape, the first cladding layer 20 is obtained by irradiating ultraviolet light on a photocurable resin through a photomask and developing the exposed resin.

As a method for forming the photocurable resin, a resin sheet may be adhered, or a liquid resin may be coated. A thickness of the first cladding layer 20 is in a range of approximately 10 μm to approximately 30 μm, for example.

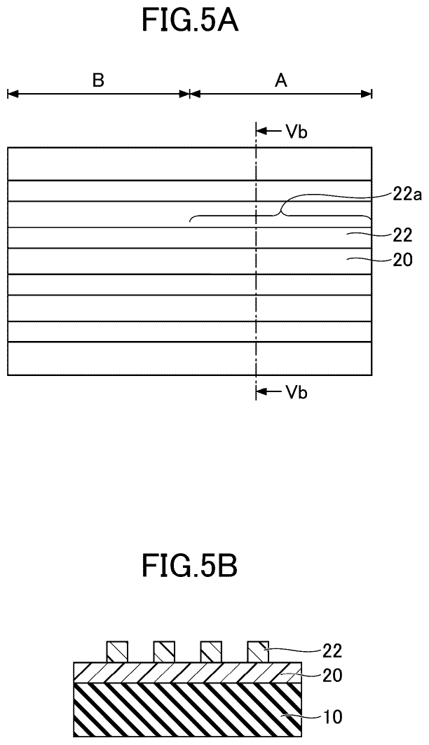

Thereafter, a photocurable resin (not illustrated) for obtaining a core layer is formed on the first cladding layer 20. In addition, the photocurable resin is irradiated with ultraviolet light through a photomask, developed, and thereafter cured by performing a heat treatment at a temperature in a range of approximately 150° C. to approximately 200° C. Hence, as illustrated in FIG. 5A and FIG. 5B, the plurality of core layers 22 are arranged side by side in the band (or strip) pattern on the first cladding layer 20. The plurality of core layers 22 are arranged to extend in a horizontal direction in each of the product regions R, and to extend in each region straddling two mutually adjacent product regions R. FIG. 5A is a plan view of the product region R, and FIG. 5B is a cross sectional view of the product region R taken along a line Vb-Vb in FIG. 5A.

As illustrated in FIG. 5A, each product region R is segmented into two regions at a center along the extending direction of the core layer 22. That is, each product region R is divided into a region A on the right side of the center, and a region B on the left side of the center. One side of the core layer 22 in an extending direction thereof, arranged in the region A of each product region R, is used as an optical coupling part 22a. Accordingly, the core layer 22, including the optical coupling part 22a in a part thereof along the extending direction, is formed on the first cladding layer 20.

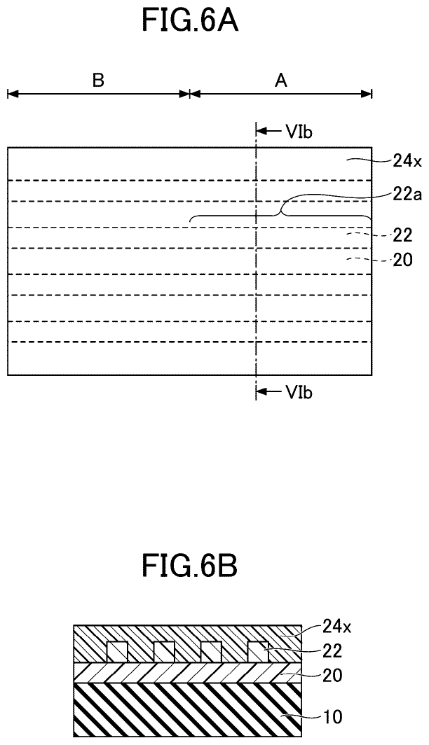

Next, as illustrated in FIG. 6A and FIG. 6B, a photocurable resin layer 24x for obtaining a second cladding layer is formed on the first cladding layer 20 and the core layer 22. The photocurable resin layer 24x is formed to have a flat upper surface in a state covering the upper surface and the side surface of the core layer 22. A material used for the photocurable resin layer 24x can be a negative photosensitive epoxy resin, a polyimide resin, or the like, for example. The photocurable resin layer 24x includes a reactive functional group contributing to photocuring, and a reactive functional group contributing to thermosetting, and is cured by photocuring and thermosetting. The photocurable resin layer 24x is an example of a photosensitive layer. The material used for the photocurable resin layer 24x can also be used for the first cladding layer 20 and the core layer 22. FIG. 6A is a plan view of the product region R, and FIG. 6B is a cross sectional view of the product region R taken along a line VIb-VIb in FIG. 6A.

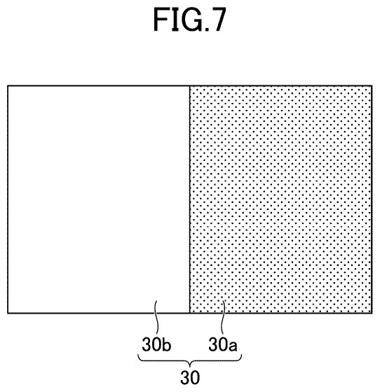

Next, as illustrated in FIG. 7, a photomask 30 is prepared. FIG. 7 partially illustrates the photomask 30 in a region corresponding to one product region R. The photomask 30 includes a light shielding part 30a, and a light transmitting part (or translucent part) 30b. The light shielding part 30a is arranged in correspondence with the region A on one side within each product region R, and is used to form an uncured portion of the photocurable resin layer 24x that is arranged in the region A and is not exposed. The light transmitting part 30b of the photomask 30 is arranged in correspondence with to the region B on the other side within each product region R, and is used to form a cured portion of the photocurable resin layer 24x that is arranged in the region B and is exposed.

Thereafter, the photocurable resin layer 24x is irradiated with ultraviolet light through the light transmitting part 30b of the photomask 30 and is exposed, thereby curing the photocurable resin layer 24x in the region B of each product region R. In this state, the photocurable resin layer 24x in the region A of each product region R is shielded from the ultraviolet light by the light shielding part 30a of the photomask 30 and is not exposed, and is thus maintained in an uncured state.

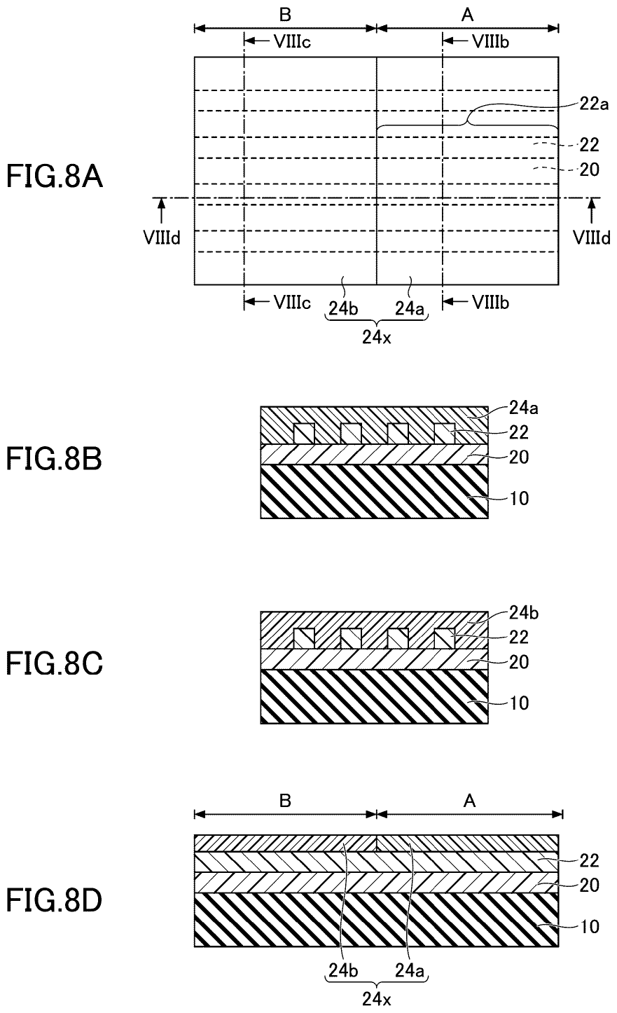

Next, a heat treatment (post-baking) is performed at a temperature in a range of 150° C. to 200° C. As a result, as illustrated in FIG. 8A through FIG. 8D, an uncured portion 24a is formed in the region A of each product region R of the photocurable resin layer 24x, and a cured portion 24b is formed in the region B of each product region R. FIG. 8A is a plan view of the product region R, and FIG. 8B through FIG. 8D are cross sectional views of the product region R. FIG. 8B corresponds to a cross sectional view taken along a line VIIIb-VIIIb in FIG. 8A, FIG. 8C corresponds to a cross sectional view taken along a line VIIIc-VIIIc in FIG. 8A, and FIG. 8D corresponds to a cross sectional view taken along a line VIIId-VIIId in FIG. 8A.

The cured portion 24b is obtained by completely curing the photocurable resin layer 24x by photocuring and thermosetting. In addition, the uncured portion 24a is obtained by subjecting the photocurable resin layer 24x only to a heat treatment at a temperature in a range of 150° C. to 200° C., without exposing the photocurable resin layer 24x, and is thus maintained in an uncured state. The uncured portion 24a and the cured portion 24b are integrally connected to each other. The uncured portion 24a is an example of a first area, and the cured portion 24b is an example of a second area.

As illustrated in FIG. 8A, FIG. 8B, and FIG. 8D, in each product region R, the optical coupling part 22a of the plurality of core layers 22 are covered with the uncured portion 24a. In addition, as illustrated in FIG. 8A, FIG. 8C, and FIG. 8D, in each product region R, a region of the plurality of core layers 22, other than the optical coupling part 22a, is covered with the cured portion 24b.

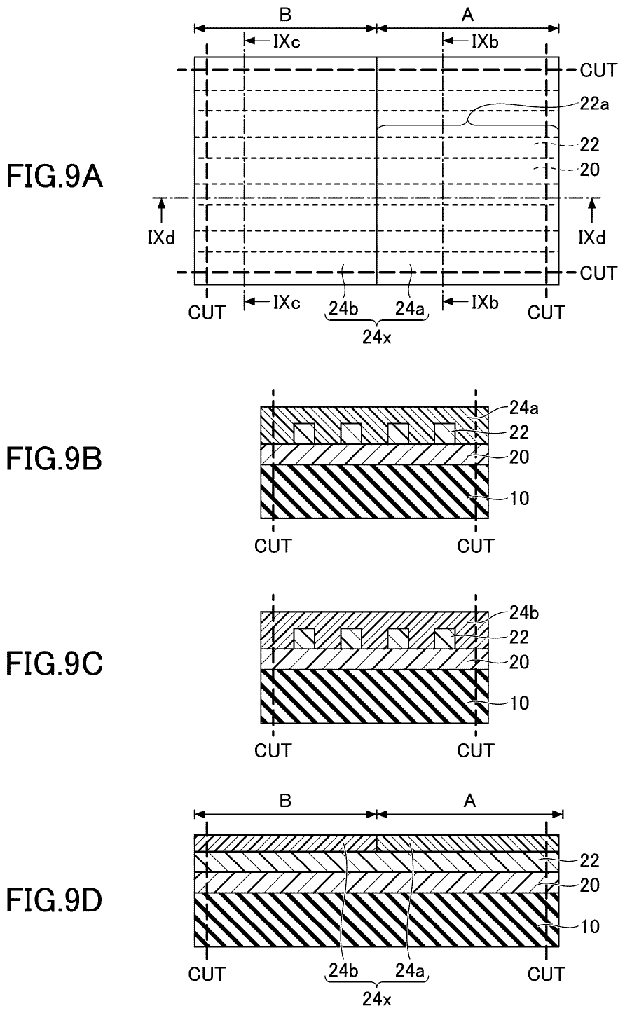

Next, as illustrated in FIG. 9A through FIG. 9D, the photocurable resin layer 24x, the core layer 22, the first cladding layer 20, and the substrate 10 are cut along the outer periphery of each product region R by a rotary blade or the like of a cutter, to be singulated. FIG. 9A is a plan view of the product region R, and FIG. 9B through FIG. 9D are cross sectional views of the product region R. FIG. 9B corresponds to a cross sectional view taken along a line IXb-IXb in FIG. 9A, FIG. 9C corresponds to a cross sectional view taken along a line IXc-IXc in FIG. 9A, and FIG. 9D corresponds to a cross sectional view taken along a line IXd-IXd in FIG. 9A.

In this state, as illustrated in FIG. 9B, the optical coupling part 22a is covered with and protected by the uncured portion 24a. For this reason, when the core layer 22 is cut, there is no possibility of damaging the optical coupling part 22a of the core layer 22, and the core layer 22 can be cut with a high reliability. Further, there is no possibility of contaminating the core layer 22 by shavings. Thus, end surfaces of the photocurable resin layer 24x, the core layer 22, the first cladding layer 20, and the substrate 10 in the extending direction of the core layer 22 are formed by cut surfaces, and coincide with one another.

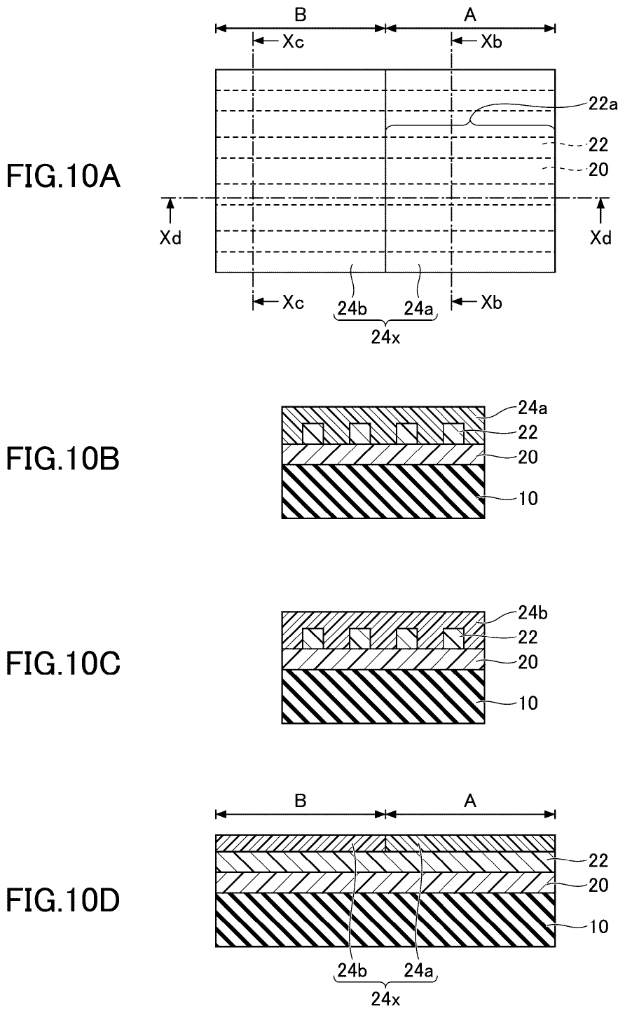

Accordingly, as illustrated in FIG. 10A through FIG. 10D, a singulated laminated structure including the substrate 10, the first cladding layer 20, the core layer 22, and the photocurable resin layer 24x is obtained. FIG. 10A is a plan view of the product region R, and FIG. 10B through FIG. 10D are cross sectional views of the product region R. FIG. 10B corresponds to a cross sectional view taken along a line Xb-Xb in FIG. 10A, FIG. 10C corresponds to a cross sectional view taken along a line Xc-Xc in FIG. 10A, and FIG. 10D corresponds to a cross sectional view taken along a line Xd-Xd in FIG. 10A.

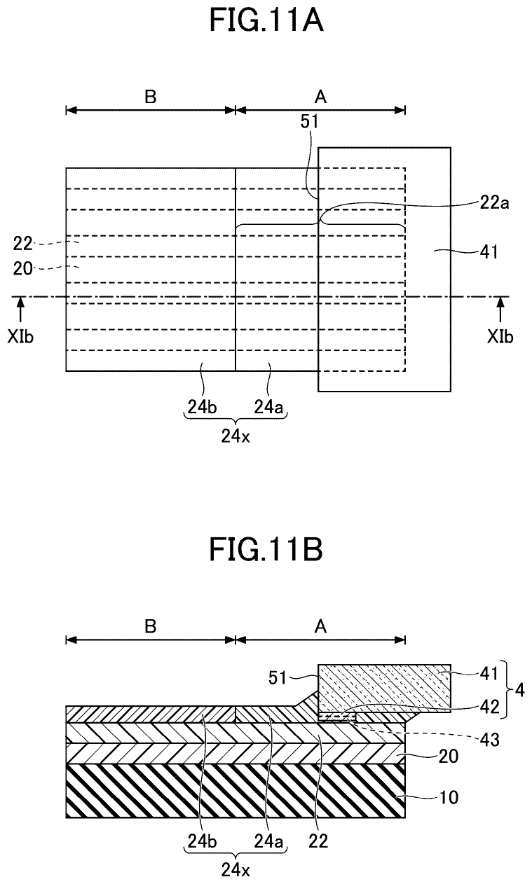

In addition, as illustrated in FIG. 11A and FIG. 11B, the optical semiconductor element 4 is prepared separately from the singulated laminated structure described above. Moreover, the optical semiconductor element 4 is pressed into the uncured portion 24a, so that the core layer 43 of the silicon waveguide 42 opposes the core layer 22, and the core layer 43 is optically coupled to the core layer 22. For example, the lower surface of the core layer 43 is arranged to oppose the upper surface of the core layer 22. FIG. 11A is a plan view of the product region R, and FIG. 11B is a cross sectional view of the product region R. FIG. 11B corresponds to a cross sectional view taken along a line XIb-XIb in FIG. 11A.

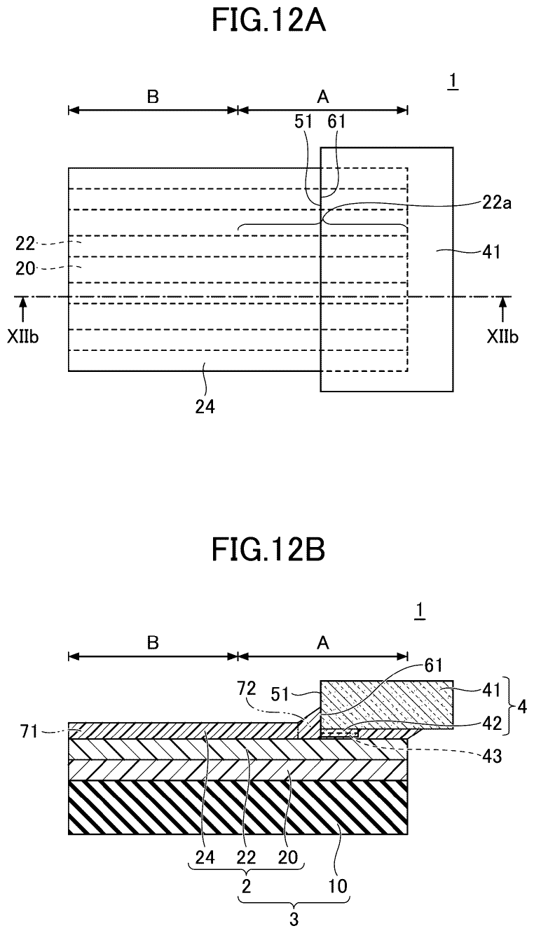

Next, as illustrated in FIG. 12A and FIG. 12B, the uncured portion 24a is cured, and the entire photocurable resin layer 24x is formed into a cured portion. The uncured portion 24a can be cured by irradiating ultraviolet light. As a result of the curing of the uncured portion 24a, the second cladding layer 24 is obtained from the photocurable resin layer 24x, and the optical waveguide 2 including the first cladding layer 20, the core layer 22, and the second cladding layer 24 is obtained. In addition, the optical waveguide substrate 3 including the substrate 10 and the optical waveguide 2 is obtained. The second cladding layer 24 functions as an adhesive, and the optical semiconductor element 4 is fixed to the substrate 10 by the second cladding layer 24 with the first cladding layer 20 interposed between the substrate 10 and the second cladding layer 24. FIG. 12A is a plan view of the product region R, and FIG. 12B is a cross sectional view of the product region R. FIG. 12B corresponds to a cross sectional view taken along a line XIIb-XIIb in FIG. 12A.

The optical waveguide device 1 according to the first embodiment can be manufactured in the manner described above.

In the present embodiment, the optical semiconductor element 4 is pressed into the uncured portion 24a of the photocurable resin layer 24x in a state where the core layer 22 is covered with the photocurable resin layer 24x, and the uncured portion 24a is cured as it is in this state. For this reason, the mixing of foreign material between the core layer 22 and the core layer 43 can be prevented. In contrast, in a case where the optical semiconductor element 4 is fixed to the optical waveguide substrate 3 using an adhesive or the like after the uncured portion 24a is removed, the core layer 22 is once exposed, and thus, there is a possibility of foreign material becoming mixed before the core layer 22 is covered with the adhesive or the like.

In addition, in the present embodiment, because it is unnecessary to remove the uncured portion 24a, it is possible to improve the throughput or the yield, compared to the case where the uncured portion 24a is removed.

Moreover, in the present embodiment, the portion where the core layer 22 and the core layer 43 are optically coupled can be protected by the second cladding layer 24, and the optical semiconductor element 4 can be fixed to the substrate 10 by the second cladding layer 24. Accordingly, it is unnecessary to use an adhesive or the like in addition to the second cladding layer 24.

Further, in the present embodiment, the uncured portion 24a can easily stabilize the orientation of the optical semiconductor element 4 during a period from the time when the optical semiconductor element 4 is pressed into the uncured portion 24a to the time when the uncured portion 24a is cured. Particularly, when the core layer 43 is arranged at a position separated from the core layer 22, the orientation of the optical semiconductor element 4 can easily be stabilized, thereby making it possible to easily obtain an excellent reliability.

The second cladding layer 24 and the photocurable resin layer 24x may be made of a positive type photosensitive material.

Alternatively, without performing the exposure using the photomask 30 after forming the photocurable resin layer 24x, the entire photocurable resin layer 24x in an uncured state may be cut (refer to FIG. 9) and the optical semiconductor element 4 may be pressed (refer to FIG. 10) into the uncured portion, and the entire photocurable resin layer 24x may thereafter be cured by performing the exposure and heat treatment (post-baking).

### Second Embodiment

Next, a second embodiment will be described. The second embodiment differs from the first embodiment mainly in the configuration of the optical waveguide substrate.

### [Structure of Optical Waveguide Device]

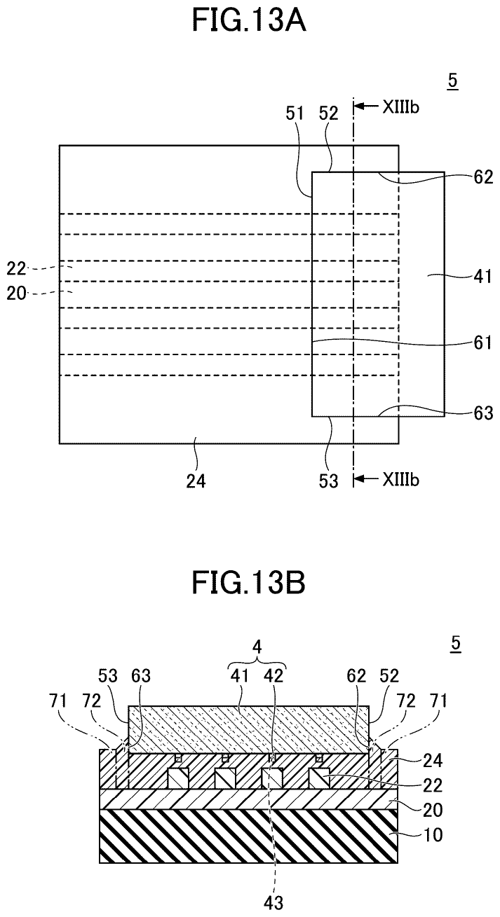

The structure of the optical waveguide device according to the second embodiment will be described. FIG. 13A and FIG. 13B are diagrams illustrating an example of the optical waveguide device according to the second embodiment. FIG. 13A is a plan view of the optical waveguide device, and FIG. 13B is a cross sectional view of the optical waveguide device taken along a line XIIIb-XIIIb in FIG. 13A.

As illustrated in FIG. 13A and FIG. 13B, in an optical waveguide device 5 according to the second embodiment, the size of the optical waveguide substrate 3 in a direction perpendicular to the extending direction of the core layer 22 in the plan view is larger than that of the first embodiment. More specifically, in the plan view, the size of the optical waveguide substrate 3 in the direction perpendicular to the extending direction of the core layer 22 is larger than the size of the optical semiconductor element 4 in the direction perpendicular to the extending direction of the core layer 22.

The optical semiconductor element 4 has a first side surface 51, a second side surface 52, and a third side surface 53 opposite to the second side surface 52. The second side surface 52 and the third side surface 53 are continuous with the first side surface 51. For example, in the plan view, an angle formed by the first side surface 51 and the second side surface 52 is 90 degrees, and an angle formed by the first side surface 51 and the third side surface 53 is 90 degrees.

In addition, the second cladding layer 24 has a first surface 61 in contact with the first side surface 51, a second surface 62 in contact with the second side surface 52, and a third surface 63 in contact with the third side surface 53. The second cladding layer 24 has the flat region 71 and the sloping region 72, similar to the first embodiment. However, in the second embodiment, the sloping region 72 includes the first surface 61, the second surface 62, and the third surface 63.

Otherwise, the structure of the second embodiment is the same as the structure of the first embodiment.

### [Method for Manufacturing Optical Waveguide Device]

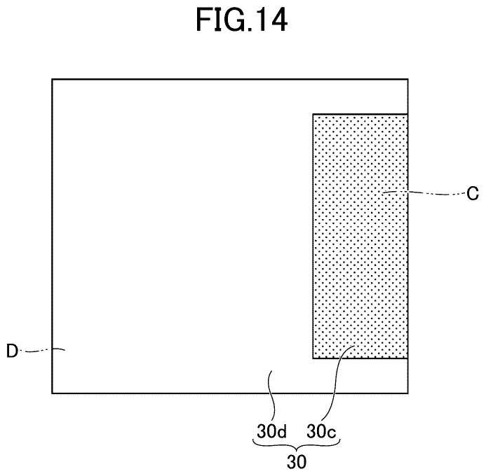

Next, a method for manufacturing the optical waveguide device according to the second embodiment will be described. FIG. 14 through FIG. 17B are diagrams illustrating the method for manufacturing the optical waveguide device according to the second embodiment.

First, the substrate 10 is prepared in the same manner as in the first embodiment (refer to FIG. 2). However, the product region R is made larger than that of the first embodiment according to the size of the optical waveguide substrate 3. Next, the processes up to the formation of the photocurable resin layer 24x are performed in the same manner as in the first embodiment (refer to FIG. 3A through FIG. 6B).

Thereafter, as illustrated in FIG. 14, the photomask 30 is prepared. FIG. 14 partially illustrates the photomask 30 in a region corresponding to one product region R, similar to FIG. 7. The photomask 30 includes a light shielding part 30c, and a light transmitting part (or translucent part) 30d. The light shielding part 30c is arranged in correspondence with a region C where the optical semiconductor element 4 is fixed in each product region R, and is used to leave the photocurable resin layer 24x arranged in the region C unexposed as an uncured portion. On the other hand, the light transmitting part 30d of the photomask 30 is arranged in correspondence with to a remaining region D of each product region R, and is used to expose the photocurable resin layer 24x arranged in the region D to form a cured portion.

Next, the photocurable resin layer 24x is irradiated with ultraviolet light through the light transmitting part 30d of the photomask 30 and exposed, thereby curing the photocurable resin layer 24x in the region D of each product region R. In this state, because the photocurable resin layer 24x in the region C of each product region R is shielded from light by the light shielding part 30c of the photomask 30, the photocurable resin layer 24x in the region C is not exposed and is maintained in an uncured state.

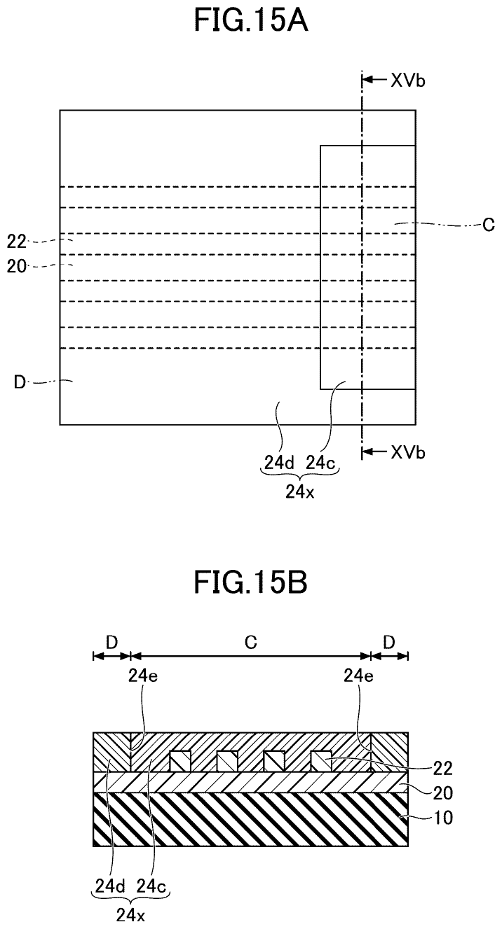

Next, a heat treatment (post-baking) is performed at a temperature in a range of 150° C. to 200° C. Hence, as illustrated in FIG. 15A and FIG. 15B, an uncured portion 24c is formed in the region C of each product region R of the photocurable resin layer 24x, and a cured portion 24d is formed in the region D of each product region R of the photocurable resin layer 24x. The cured portion 24d has a wall surface 24e in contact with the uncured portion 24c. FIG. 15A is a plan view of the product region R, and FIG. 15B is a cross sectional view of the product region R taken along a line XVb-XVb in FIG. 15A.

The cured portion 24d is obtained by completely curing the photocurable resin layer 24x by photocuring and thermosetting. In addition, the uncured portion 24c is obtained by merely heating the photocurable resin layer 24x at a temperature in the range of 150° C. to 200° C. without exposure, and is thus maintained in the uncured state. The uncured portion 24c and the cured portion 24d are integrally connected to each other. The uncured portion 24c is an example of a first area, and the cured portion 24d is an example of a second area.

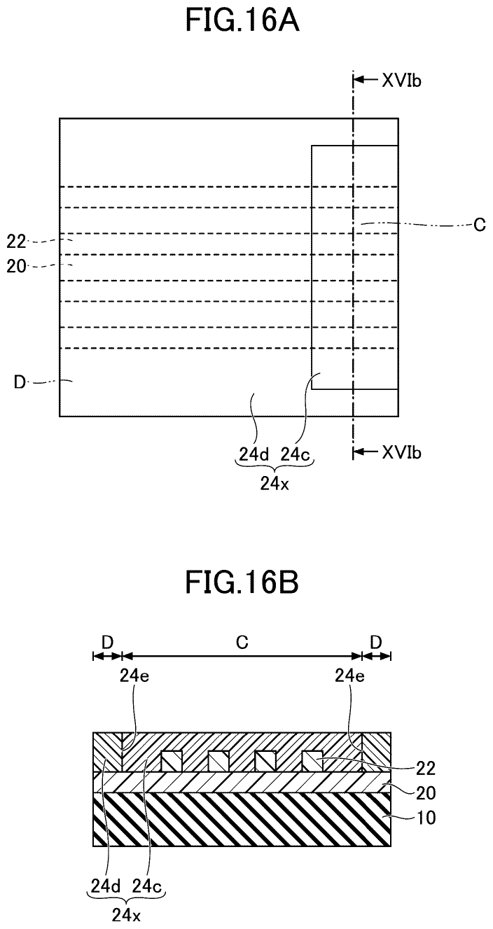

Next, as in the first embodiment, the photocurable resin layer 24x, the core layer 22, the first cladding layer 20, and the substrate 10 are cut along the outer periphery of each product region R by the rotary blade or the like of the cutter, to be singulated. Accordingly, as illustrated in FIG. 16A and FIG. 16B, a singulated laminated structure including the substrate 10, the first cladding layer 20, the core layer 22, and the photocurable resin layer 24x is obtained. FIG. 16A is a plan view of the product region R, and FIG. 16B is a cross sectional view of the product region R taken along a line XVIb-XVIb in FIG. 16A.

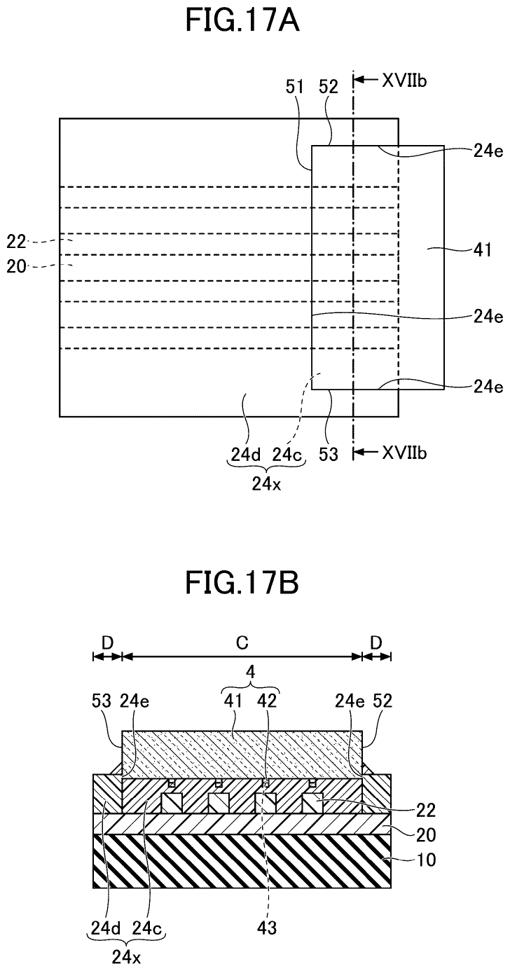

Moreover, as illustrated in FIG. 17A and FIG. 17B, the optical semiconductor element 4 is prepared separately from the singulated laminated structure described above. Then, the optical semiconductor element 4 is pressed into the uncured portion 24c, so that the core layer 43 of the silicon waveguide 42 opposes the core layer 22, and the core layer 43 is optically coupled to the core layer 22. In this state, the first side surface 51, the second side surface 52, and the third side surface 53 of the optical semiconductor element 4 are guided by the wall surface 24e of the cured portion 24d in contact with the uncured portion 24c. Accordingly, the optical semiconductor element 4 can easily be aligned and positioned. FIG. 17A is a plan view of the product region R, and FIG. 17B is a cross sectional view of the product region R taken along a line XVIIb-XVIIb in FIG. 17A.

Next, the uncured portion 24c is cured to make the entire photocurable resin layer 24x the cured portion. The uncured portion 24c can be cured by irradiating ultraviolet light thereon. As a result of the curing the uncured portion 24a, the second cladding layer 24 is obtained from the photocurable resin layer 24x, and the optical waveguide 2 including the first cladding layer 20, the core layer 22, and the second cladding layer 24 is obtained.

The optical waveguide device 5 (refer to FIG. 13A and FIG. 13B) according to the second embodiment can be manufactured in the manner described above.

The second embodiment can also obtain the same effects as those obtainable by the first embodiment. In addition, according to the second embodiment, the core layer 43 of the silicon waveguide 42 can be positioned and aligned with respect to the core layer 22 of the optical waveguide 2 with a high accuracy.

A margin may be provided between the cured portion 24d and the optical semiconductor element 4, to such an extent that the optical coupling between the core layer 22 and the core layer 43 will not be inhibited.

According to the present disclosure, it is possible to prevent mixing of the foreign material.

Various aspects of the subject matter described herein may be set out non-exhaustively in the following numbered clauses:

1. A method for manufacturing an optical waveguide device, comprising:
forming a first cladding layer on a substrate;
forming a first core layer on the first cladding layer;
forming an uncured photosensitive resin layer on the first cladding layer and the first core layer;
pressing an optical semiconductor element, provided with a silicon waveguide having a second core layer, into a photosensitive resin layer so that the second core layer opposes the first core layer, thereby optically coupling the second core layer to the first core layer; and
after the pressing the optical semiconductor element into the photosensitive resin layer, curing the photosensitive resin layer so as to obtain a second cladding layer from the photosensitive resin layer,
wherein the optical semiconductor element is fixed to the substrate by the second cladding layer.

2. The method for manufacturing the optical waveguide device according to clause 1, further comprising:
forming an uncured first area covering a first side of the first core layer in an extending direction thereof and a cured second region covering a second side of the first core layer opposite to the first side in the extending direction thereof, by curing a part of the uncured photosensitive resin layer between the forming the uncured photosensitive resin layer and the pressing the optical semiconductor element,
wherein the pressing the optical semiconductor element presses the optical semiconductor element into the uncured first area.

3. The method for manufacturing the optical waveguide device according to clause 2, wherein
the optical semiconductor element includes:
   a first side surface;
   a second side surface continuous with the first side surface; and
   a third side surface continuous with the first side surface on a side opposite to the second side surface, and
the cured second region has a wall surface that guides the first side surface, the second side surface, and the third side surface.

4. The method for manufacturing the optical waveguide device according to clause 1 or 2, wherein the photosensitive resin layer includes an epoxy resin or a polyimide resin.

5. The method for manufacturing the optical waveguide device according to clause 1 or 2, wherein the second core layer is arranged at a position separated from the first core layer.

Although the embodiments are numbered with, for example, “first,” or “second,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical waveguide device comprising:
an optical waveguide substrate; and
an optical semiconductor element including a silicon waveguide and mounted on the optical waveguide substrate, wherein
the optical waveguide substrate includes:
a substrate;
a first cladding layer formed on the substrate;
a first core layer formed on the first cladding layer; and
a second cladding layer formed on the first cladding layer and the first core layer,
the silicon waveguide includes a second core layer optically coupled to the first core layer, and
the optical semiconductor element is fixed to the substrate by the second cladding layer.

2. The optical waveguide device as claimed in claim 1, wherein the second cladding layer includes an epoxy resin or a polyimide resin.

3. The optical waveguide device as claimed in claim 1, wherein the first core layer and the second core layer are separated from each other.

4. The optical waveguide device as claimed in claim 1, wherein
the optical semiconductor element includes:
a first side surface;
a second side surface continuous with the first side surface; and
a third side surface continuous with the first side surface on a side opposite to the second side surface,
the second cladding layer includes:
a first surface in contact with the first side surface;
a second surface in contact with the second side surface; and
a third surface in contact with the third side surface.
